(19) United States
(12) Patent Application Publication
(10) Pub. No.: US 2005/0120252 A1
(43) Pub. Date: Jun. 2, 2005

(54) Electric apparatus and processor speed control method

(75) Inventor: Katsuki Uwatoko, Tachikawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 10/958,140

(22) Filed: Oct. 5, 2004

(30) Foreign Application Priority Data
Nov. 28, 2003 (JP) 2003-400788

(51) Int. Cl. G06F 9/46

(52) U.S. Cl. 713/300

(57) ABSTRACT

An electric apparatus executes a plurality of tasks including a real-time task for executing real-time processing. The electric apparatus includes a processor, a unit which executes a scheduling process of preferentially assigning the real-time task to the processor in accordance with schedule information for controlling an execution sequence of the tasks, a sensor which senses the temperature of the processor, and a unit which executes, if the temperature of the processor sensed by the sensor is higher than a given threshold value, a process of assigning a processor stop task to the processor to periodically execute the processor stop task in a time except for an execution term of the real-time task.

### CROSS-REFERENCE TO RELATED APPLICATIONS

This application is based upon and claims the benefit of priority from prior Japanese Patent Application No. 2003-400788, filed Nov. 28, 2003, the entire contents of which are incorporated herein by reference.

### BACKGROUND OF THE INVENTION

1. Field of the Invention

The present invention relates to an electric apparatus including a processor, and a processor speed control method used in the electric apparatus.

2. Description of the Related Art

Recently, techniques for controlling the operating speed of a processor have been developed. For example, it is possible, by lowering the frequency of a clock signal to be supplied to a processor, to suppress heat generation by the processor and reduce the power consumption of the processor.

U.S. Pat. No. 5,189,647 discloses a system which stops a clock to be supplied to a processor by using a clock control program executed when the processor became an idle state.

In this system, however, the clock control system is not executed unless the processor became the idle state. Therefore, as long as an executable task is present, the processor keeps operating at a speed of 100%.

It is, however, very dangerous to keep the processor operating at a speed of 100%. This is so because the temperature of the processor may exceed its safe operation guaranteed temperature.

Also, in a real-time system, the frequency of a clock to be supplied to a processor cannot be simply lowered. This is so because, if the clock frequency is lowered during a period in which the processor is executing a real-time task, this real-time task may not be completely executed within a predetermined time constraint.

### BRIEF SUMMARY OF THE INVENTION

According to an embodiment of the present invention, there is provided an electric apparatus for executing a plurality of tasks including a real-time task for executing real-time processing, comprising a processor, means for executing a scheduling process of preferentially assigning the real-time task to the processor in accordance with schedule information for controlling an execution sequence of the plurality of tasks, a sensor which senses a temperature of the processor, and means for executing, if the temperature of the processor sensed by the sensor is higher than a given threshold value, a process of assigning a processor stop task to the processor to periodically execute the processor stop task in a time except for an execution term of the real-time task.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the system configuration of an electric apparatus according to an embodiment of the present invention;

FIG. 2 is a view showing the way real-time tasks and a CPU stop task are periodically executed in the system shown in FIG. 1;

FIG. 3 is a view showing an example of scheduling when the temperature of a CPU of the system shown in FIG. 1 is equal to or lower than a threshold value;

FIG. 4 is a view showing an example of scheduling when the temperature of the CPU of the system shown in FIG. 1 is higher than the threshold value;

FIG. 5 is a view showing the arrangement of a scheduling queue used in the system shown in FIG. 1;

FIG. 6 is a view showing an example of scheduling executed by using the scheduling queue shown in FIG. 5 when the temperature of the CPU is equal to or lower than the threshold value;

FIG. 7 is a view showing an example of scheduling executed by using the scheduling queue shown in FIG. 5 when the temperature of the CPU is higher than the threshold value; and

FIG. 8 is a flowchart showing the procedure of a CPU speed control process executed in the system shown in FIG. 1.

### DETAILED DESCRIPTION OF THE INVENTION

An embodiment of the present invention will be described below with reference to the accompanying drawing.

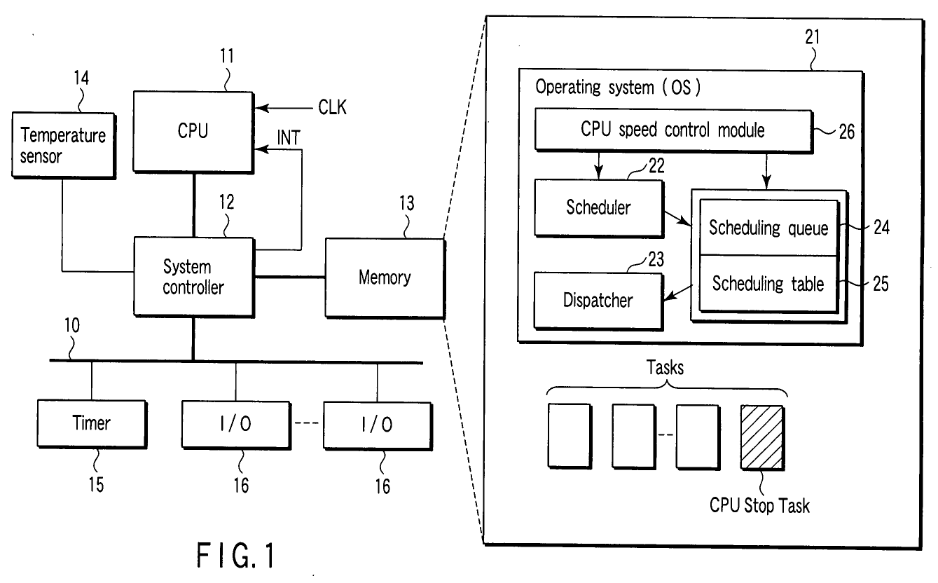

FIG. 1 shows the configuration of an electric apparatus according to the embodiment of the present invention. This electric apparatus is an apparatus which processes multimedia data such as audio and video data. The electric apparatus includes an embedded system which functions as a real-time system. This embedded system is an information processing apparatus including a processor. As shown in FIG. 1, the embedded system includes a bus 10, CPU (Central Processing Unit) 11, system controller 12, memory 13, temperature sensor 14, system timer 15, and various I/O devices 16.

The CPU 11 is a processor for controlling the operation of this electric apparatus. The CPU 11 executes an operating system (OS) 21 and various application programs loaded into the memory 13. The CPU 11 operates in synchronism with a clock signal CLK. The system controller 12 is a bridge device which connects a processor bus of the CPU 11 and the bus 10 in two ways. The system controller 12 includes a memory controller for controlling the memory 13. The system controller 12 also includes an interrupt controller. This interrupt controller supplies an interrupt signal INT to the CPU 11 in response to an interrupt request signal from each of the system timer 15 and various I/O devices 16. The system timer 15 generates an interrupt request signal (timer interrupt) at a predetermined time interval.

The temperature sensor 14 senses the temperature of the CPU 11. The temperature of the CPU 11 sensed by the temperature sensor 14 is set in an internal register of the system controller 12. The temperature sensor 14 is positioned on a chip of the CPU 11 or in the vicinity of the CPU 11. The temperature of the CPU 11 is raised by heat generated by the CPU 11 itself. If the CPU 11 keeps operating at an operating speed of 100%, the temperature of the CPU 11 may exceed the safe operating temperature range of the CPU 11. The temperature sensor 14 is used to monitor whether the temperature of the CPU 11 falls within this safe operating temperature range.

In this embodiment, if the temperature of the CPU 11 sensed by the temperature sensor 14 is higher than a predetermined threshold value, a CPU speed control process is executed to decrease the average operating speed of the CPU 11. For example, the threshold value is set at a value slightly lower than the upper limit of the safe operating temperature range of the CPU 11. The CPU speed control process periodically stops the operation of the CPU 11 in order to insert a CPU operation stop period once for a certain predetermined time. For example, the CPU speed control process periodically stops the operation of the CPU 11 so as to stop the operation of the CPU 11 only for a period of 200 ms per second. Consequently, the average operating speed of the CPU 11 is decreased to 80% of a highest operating speed.

The CPU speed control process is executed by using a processor stop task (CPU stop task) which is prepared to stop the operation of the CPU 11. This processor stop task (CPU stop task) includes an instruction, such as a HALT instruction, for stopping the operation of the CPU 11. When the processor stop task (CPU stop task) is dispatched to the CPU 11, the CPU 11 executes the HALT instruction of this processor stop task (CPU stop task), thereby stopping the operation of the CPU 11 itself. In this case, the internal clock of the CPU 11 is also stopped, so the core unit of the CPU 11 stops operating.

The operating system (OS) 21 is so designed as to support a multitask function. The OS 21 includes a scheduler 22 and dispatcher 23. The scheduler 22 determines a task to which a CPU time is to be allocated next. The scheduler 22 schedules tasks including real-time tasks and non-real-time tasks. In this scheduling, a real-time task is assigned to the CPU 11 in preference to a non-real-time task. The scheduling process is executed in accordance with schedule information for controlling the execution sequence of the tasks. A real-time task is a task for executing real-time processing, i.e., a task which must be completely processed within a certain time constraint.

The scheduler 22 manages the schedule information by using at least one of a scheduling queue 24 and scheduling table 25. The scheduling queue 24 is a queue for registering executable tasks. As the schedule information described above, the scheduling queue 24 manages priority information indicating the priority level of each task. A real-time task has a highest priority level, and each non-real-time task is assigned a priority level lower than that of a real-time task. Accordingly, real-time tasks are executed in preference to non-real-time tasks.

The scheduling table 25 is a table for registering tasks to be periodically executed. As the schedule information described above, the scheduling table 25 manages processor time allocation information for reserving the execution term of a real-time task. Real-time tasks are registered in the scheduling table 25, and the execution start timings and execution terms of these real-time tasks are reserved. In this manner, the execution start timing and execution term of each real-time task are defined. Non-real-time tasks are executed by using a time period except for the execution terms of real-time tasks. The scheduling table 25 is used to periodically allocate a CPU time to each real-time task at a predetermined timing.

The dispatcher 23 dispatches tasks to the CPU 11 upon referring to the scheduling queue 24 or scheduling table 25. When the dispatcher 23 determines that the scheduler 22 requires a task switch (context switch), it looks up the scheduling queue 24 or scheduling table 25, and executes a task switch. The combination of the scheduler 22 and the dispatcher 23 may be called a scheduler.

The OS 21 further includes a CPU speed control module 26. The CPU speed control module 26 executes the CPU speed control process described above. If the temperature of the CPU 11 is higher than a certain threshold value, the CPU speed control module 26 executes a process of assigning the CPU stop task to the CPU 11 to periodically execute the CPU stop task by the CPU 11 in a time except for the execution terms of the real-time tasks. This process of assigning the CPU stop task to the CPU 11 is implemented by changing the schedule information.

More specifically, the CPU speed control module 26 executes (1) a process of changing the priority level of the CPU stop task so that a second highest priority level next to the priority level assigned to real-time tasks is assigned to the CPU stop task, or (2) a process of reserving the execution term of the CPU stop task in a term except for the execution terms of real-time tasks.

The CPU speed control module 26 requests the scheduler 22 to update the schedule information, or directly updates the scheduling queue 24 or scheduling table 25, thereby changing the priority level of the CPU stop task or reserving the execution term of the CPU stop task.

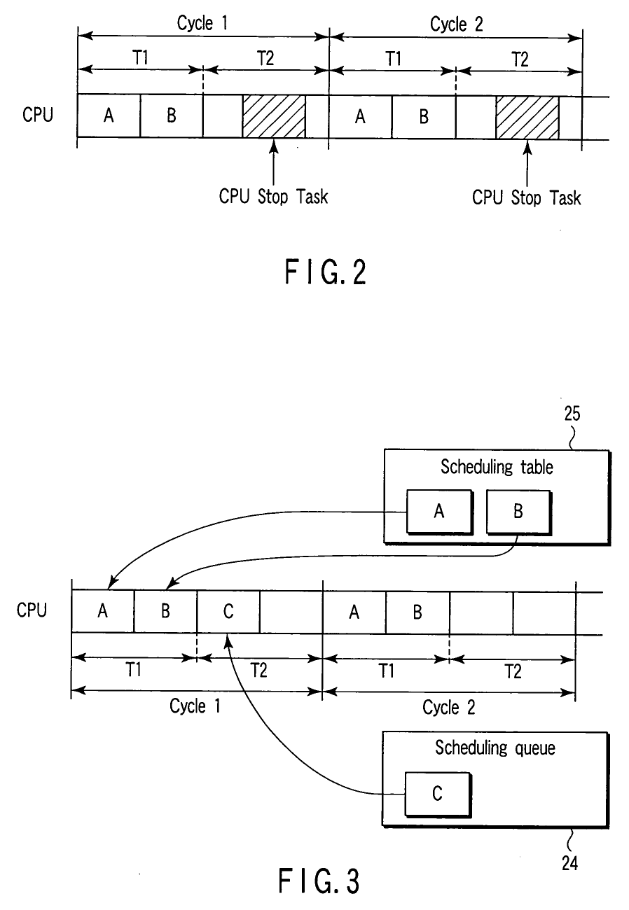

A method of periodically executing the CPU stop task by updating the processor time allocation information will be described below with reference to FIGS. 2 to 4.

FIG. 2 shows the method by which real-time tasks and the CPU stop task are periodically executed in accordance with the processor time allocation information in the scheduling table 25. In this example shown in FIG. 2, a term (period) T1 for executing real-time processing and a term (period) T2 for executing non-real-time processing are defined in each cycle time. CPU times are allocated to two real-time tasks A and B during the period T1 in each cycle time. A CPU time is allocated to the CPU stop task during the term T2 in each cycle time. The operation of the CPU 11 is stopped during the term corresponding to the CPU time allocated to the CPU stop task. During a term except for the CPU time allocated to the CPU stop task, the CPU 11 operates at an operating speed of 100%. If the length of the CPU time allocated to the CPU stop task is 20% of the length of one cycle time, the average operating speed of the CPU 11 is decreased to 80%. The real-time tasks A and B are always executed by the CPU 11 which operates at an operating speed of 100%. Accordingly, the operating speed of the CPU 11 can be decreased without impairing any real-time processing.

FIG. 3 shows scheduling when the temperature of the CPU 11 is equal to or lower than the threshold value. The real-time tasks A and B are registered in the scheduling table 25, and CPU times to be allocated to the real-time tasks A and B are reserved.

The real-time tasks A and B are executed in the term T1 of each cycle time in accordance with the CPU time allocation information. A non-real-time task C is registered in the scheduling queue 24. In the term T2 of each cycle time, the non-real-time task C registered in the scheduling queue 24 is executed.

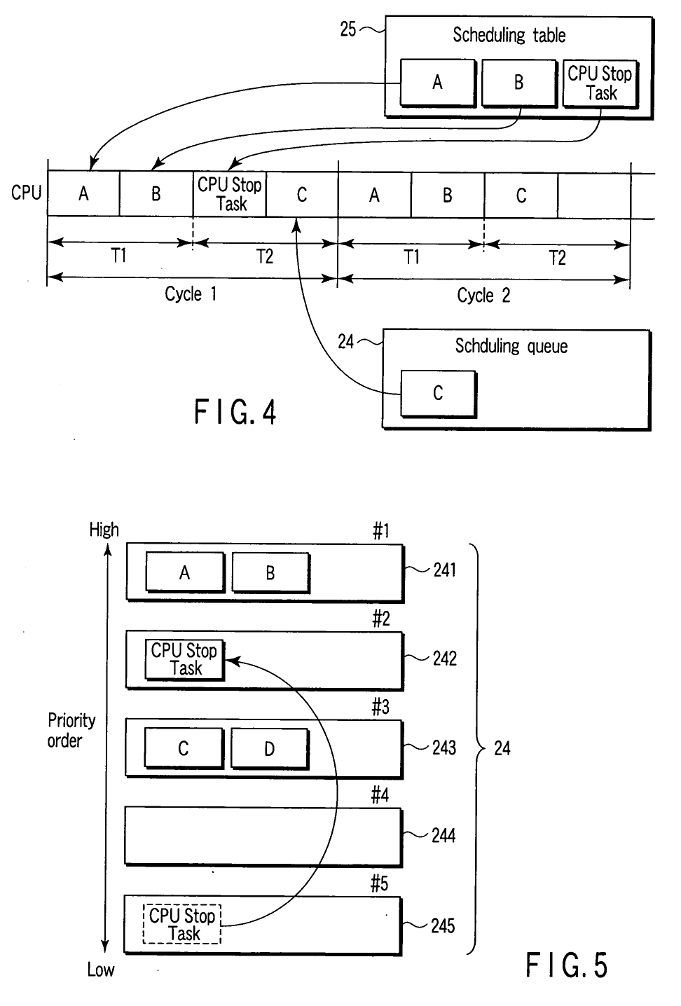

FIG. 4 shows scheduling when the temperature of the CPU 11 is higher than the threshold value. The CPU speed control module 26 registers the CPU stop task in the scheduling table 25 and reserves a CPU time to be allocated to the CPU stop task, so that the execution term of the CPU stop task is reserved in the term T2 of each cycle time in preference to the each of the non-real-time tasks. The non-real-time task C registered in the scheduling queue 24 is executed, during the term T2 in each cycle time, by using a term except for the execution term reserved for the CPU stop task.

A method of periodically executing the CPU stop task by updating the priority information will be explained below with reference to FIGS. 5 to 7.

FIG. 5 shows the arrangement of the scheduling queue 24. The scheduling queue 24 includes several scheduling queues having different priority levels. For example, the scheduling queue 24 consists of five scheduling queues 241 to 245 corresponding to five priority levels. Real-time tasks A and B are registered in the scheduling queue 241 having a highest priority level. Non-real-time tasks C and D are registered in, e.g., the scheduling queue 243. The CPU stop task is usually registered in the scheduling queue 245 having a lowest priority level. If the temperature of the CPU 11 is higher than the threshold value, the CPU speed control module 26 changes the priority level of the CPU stop task to register this CPU stop task in the scheduling queue 242 assigned a second priority level. Consequently, the CPU stop task is executed, in preference to the non-real-time tasks C and D, during a term except for the execution terms of the real-time tasks A and B.

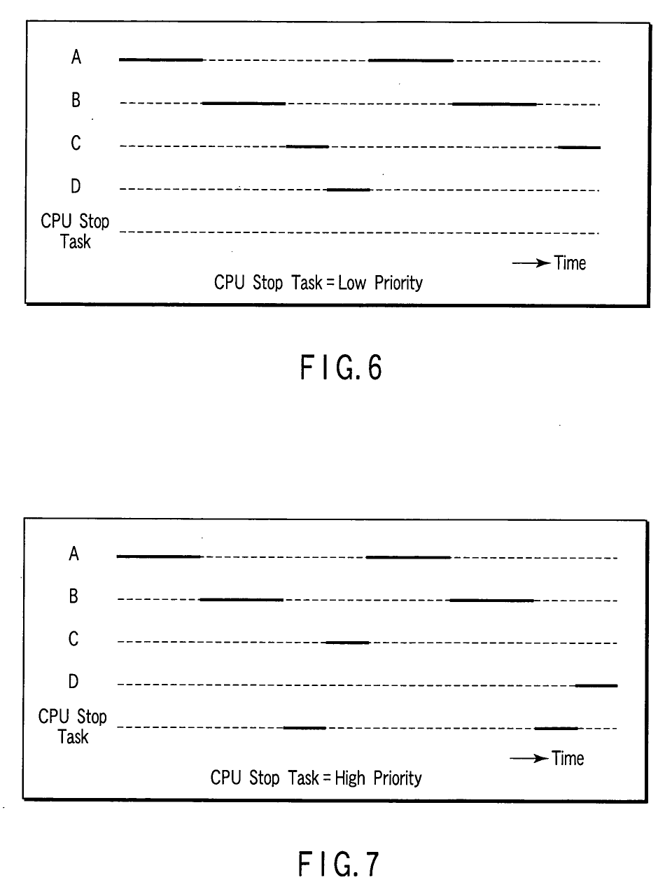

FIG. 6 shows scheduling when the temperature of the CPU 11 is equal to or lower than the threshold value. The tasks A, B, C, and D are executed in descending order of priority level. Since the priority level of the CPU stop task is lowest, the CPU stop task is not executed as long as another executable task is present.

FIG. 7 shows scheduling when the temperature of the CPU 11 is higher than the threshold value. The priority level of the CPU stop task is changed to a second highest level next to the priority level of the real-time tasks A and B. Accordingly, the tasks A and B, CPU stop task, and tasks C and D are executed in turn in descending order of priority level.

Comparison of FIGS. 6 and 7 reveal that the execution timings of the real-time tasks A and B are the same before and after the priority level of the CPU stop task is changed.

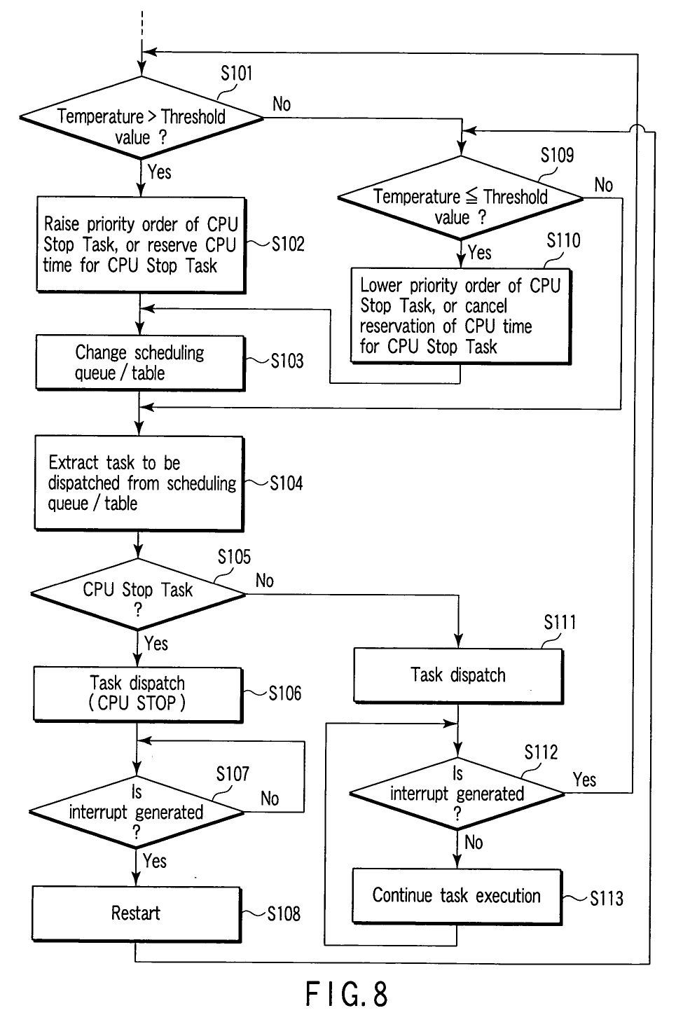

The scheduling process executed by the OS 21 will be explained below with reference to a flowchart in FIG. 8.

The CPU speed control module 26 checks whether the temperature of the CPU 11 sensed by the temperature sensor 14 is higher than the threshold value (step S101). In step S101, the CPU speed control module 26. reads the CPU temperature set in the register of the system controller 12, and compares the read CPU temperature with the threshold value. It is also possible to supply an interrupt signal from the system controller 12 (or from the temperature sensor 14) to the CPU 11, and notifies the CPU speed control module 26 that the CPU temperature is higher than the threshold value.

If the temperature of the CPU 11 sensed by the temperature sensor 14 is higher than the threshold. value (YES in step S101), the CPU speed control module 26 requests the scheduler 22 to raise the priority level of the CPU stop task, or reserve a CPU time to be allocated to the CPU stop task (step S102). In accordance with this request from the CPU speed control module 26, the scheduler 22 updates the priority information of the scheduling queue 24 or the CPU time allocation information of the scheduling table 25 (step S103).

In step S103, the scheduler 22 executes a process of changing the priority information such that the priority level of the CPU stop task becomes a second highest priority level next to the priority level of real-time tasks (i.e., becomes a priority level intermediate between the priority level of real-time tasks and that of non-real-time tasks), or a process of changing the CPU time allocation information such that a CPU time is reserved for the CPU stop task.

The dispatcher 23 extracts a task to be executed next from the scheduling queue 24 or scheduling table 25 (step S104). If this task to be executed next is the CPU stop task (YES in step S105), the CPU stop task is dispatched and executed by the CPU 11 (step S106). Since the CPU stop task contains a HALT instruction, the operation of the CPU 11 is stopped when the CPU 11 executes the CPU stop task. If an interrupt signal such as a timer interrupt is input as a scheduling event to the CPU 11 (YES in step S107), the CPU 11 restarts the operation (step S108).

On the other hand, if the task to be executed next is a task other than the CPU stop task (NO in step S105), a real-time task or non-real-time task is dispatched and executed by the CPU 11 (step Sill). This real-time task or non-real-time task dispatched by the CPU 11 is kept executed (step S113) until an interrupt signal such as a timer interrupt is input as a scheduling event to the CPU 11 (NO in step S112). If an interrupt signal such as a timer interrupt is input as a scheduling event to the CPU 11 (YES in step S112), the flow returns to the process in step S101.

When the CPU 11 restarts the operation (step S108), the CPU speed control module 26 checks whether the temperature of the CPU 11 sensed by the temperature sensor 14 is equal to or lower than the threshold value (step S109). If the temperature of the CPU 11 is equal to or lower than the threshold value (YES in step S109), the CPU speed control module 26 requests the scheduler 22 to lower the priority level of the CPU stop task, or cancel the reservation of a CPU time for the CPU stop task (step S110). In accordance with this request from the CPU speed control module 26, the scheduler 22 updates the priority information of the scheduling queue 24 or the CPU time allocation information of the scheduling table 25 (step S103). After that, the average operating speed of the CPU 11 becomes at the operating speed of 100%.

If the temperature of the CPU 11 is still higher than the threshold value (NO in step S109), the processes in steps S110 and S103 are not executed. The CPU stop task is periodically executed until the temperature of the CPU 11 becomes equal to or lowers than the threshold value.

It is also possible to check, whenever the CPU 11 restarts the operation, the length of the time elapsed since the CPU stop task is dispatched, and to keep executing the CPU stop task until the elapsed time reaches a predetermined time. In this case, the process of dispatching the CPU stop task to the CPU 11 is continuously repeated several times.

In this embodiment as described above, if the temperature of the CPU 11 is higher than the threshold value, the processor stop task is periodically executed, so the average operating speed of the processor can be decreased. In addition, the execution term of the processor stop task is allocated to a term except for the execution terms of real-time tasks. Therefore, the average operating speed of the CPU 11 can be decreased without adversely affecting the operation of a real-time task. As a consequence, the CPU 11 can be safely operated without deteriorating the real-time properties.

Furthermore, the processor stop task can be periodically executed only by changing the priority order of the CPU stop task, or reserving a CPU time to be allocated to the CPU stop task. This makes it unnecessary to change the regular scheduling algorithm of the OS 21.

Also, the CPU speed control process of this embodiment is implemented by a computer program. Accordingly, the same effect as in this embodiment can be readily obtained only by installing this computer program in an ordinary computer by using a computer-readable storage medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. An electric apparatus for executing a plurality of tasks including a real-time task for executing real-time processing, comprising:
a processor;
means for executing a scheduling process of preferentially assigning the real-time task to the processor in accordance with schedule information for controlling an execution sequence of the tasks;
a sensor which senses a temperature of the processor; and
means for executing, if the temperature of the processor sensed by the sensor is higher than a given threshold value, a process of assigning a processor stop task to the processor to periodically execute the processor stop task in a time except for an execution term of the real-time task.

2. An apparatus according to claim 1, wherein
the schedule information contains information indicating a priority level assigned to each of the tasks, and
the means for executing the process of assigning the processor stop task to the processor includes means for changing a priority level assigned to the processor stop task to assign the processor stop task a second highest priority level next to a priority level assigned to the real-time task.

3. An apparatus according to claim 1, wherein
the schedule information contains information indicating a priority level assigned to each of the tasks, and
the means for executing the process of assigning the processor stop task to the processor includes means for changing a priority level assigned to the processor stop task from a lowest priority level to a second highest priority level next to a priority level assigned to the real-time task.

4. An apparatus according to claim 1, wherein
the schedule information contains processor time allocation information for reserving an execution term of the real-time task, and
the means for executing the process of assigning the processor stop task to the processor includes means for reserving an execution term of the processor stop task in the time except for an execution term of the real-time task.

5. An apparatus according to claim 1, wherein
the tasks including a non-real-time task,
the means for executing the scheduling process includes means for allocating the execution term of the real-time task to a first period in each cycle time, and allocating an execution term of the non-real-time task to a second period in each cycle time, and
the means for executing the process of assigning the processor stop task to the processor includes means for reserving an execution term of the processor stop task in the second period of each cycle time in preference to the non-real-time task.

6. A method of controlling an operating speed of a processor for executing a plurality of tasks including a real-time task for executing real-time processing, comprising:
executing a scheduling process of preferentially assigning the real-time task to the processor in accordance with the schedule information for. controlling an execution sequence of the tasks;
checking whether a temperature of the processor is higher than a given threshold value; and
executing, if the temperature of the processor is higher than the given threshold value, a process of assigning a processor stop task to the processor to periodically execute the processor stop task in a time except for an execution term of the real-time task.

7. A method according to claim 6, wherein
the schedule information contains information indicating a priority level assigned to each of the tasks, and
executing the process of assigning the processor stop task to the processor includes changing a priority level assigned to the processor stop task to assign the processor stop task a second highest priority level next to a priority level assigned to the real-time task.

8. A method according to claim 6, wherein
the schedule information contains information indicating a priority level assigned to each of the tasks, and
executing the process of assigning the processor stop task to the processor includes changing a priority level assigned to the processor stop task from a lowest priority level to a second highest priority level next to a priority level assigned to the real-time task.

9. A method according to claim 6, wherein
the schedule information contains processor time allocation information for reserving an execution term of the real-time task, and
executing the process of assigning the processor stop task to the processor includes reserving an execution term of the processor stop task in the time except for an execution term of the real-time task.

10. A method according to claim 6, wherein
the tasks including a non-real-time task,
executing the scheduling process includes allocating the execution term of the real-time task to a first period in each cycle time, and allocating an execution term of the non-real-time task to a second period in each cycle time, and
executing the process of assigning the processor stop task to the processor includes reserving an execution term of the processor stop task in the second period of each cycle time in preference to the non-real-time task.

11. An electric apparatus for executing a plurality of tasks including a real-time task for executing real-time processing, comprising:
a processor;
a scheduling unit configured to execute a scheduling process of preferentially assigning the real-time task to the processor in accordance with schedule information for controlling an execution sequence of the tasks;
a sensor which senses a temperature of the processor; and
a speed control unit configured to control of a speed of the processor, the speed control unit executing, if the temperature of the processor sensed by the sensor is higher than a given threshold value, a process of assigning a processor stop task to the processor to periodically execute the processor stop task in a time except for an execution term of the real-time task, the processor stop task including an instruction for stopping an operation of the processor.

12. An apparatus according to claim 11, wherein
the schedule information contains information indicating a priority level assigned to each of the tasks, and
the speed control unit is configured to change a priority level assigned to the processor stop task to assign the processor stop task a second highest priority level next to a priority level assigned to the real-time task.

13. An apparatus according to claim 11, wherein
the schedule information contains information indicating a priority level assigned to each of the tasks, and
the speed control unit is configured to change a priority level assigned to the processor stop task from a lowest priority level to a second highest priority level next to a priority level assigned to the real-time task.

14. An apparatus according to claim 11, wherein
the schedule information contains processor time allocation information for reserving an execution term of the real-time task, and
the speed control unit is configured to reserve an execution term of the processor stop task in the time except for an execution term of the real-time task.

15. An apparatus according to claim 11, wherein
the tasks including a non-real-time task,
the scheduling unit is configured to allocate the execution term of the real-time task to a first period in each cycle time, and allocate an execution term of the non-real-time task to a second period in each cycle time, and
the speed control unit is configured to reserve an execution term of the processor stop task in the second period of each cycle time in preference to the non-real-time task.
